(19) United States
(12) Patent Application Publication
(10) Pub. No.: US 2008/0063765 A1
(43) Pub. Date: Mar. 13, 2008

(54) Protein and calcium fortification system for clear and opaque beverages

(75) Inventors: David M. Barbano, Dryden, NY (US); Noriko Misawa, Tokyo (JP)

Correspondence Address: SCHWEGMAN, LUNDBERG & WOESSNER, P.A., P.O. BOX 2938, MINNEAPOLIS, MN, 55402, US

(73) Assignee: Cornell Research Foundation, Inc.

(21) Appl. No.: 11/805,412

(22) Filed: May 23, 2007

Related U.S. Application Data
(63) Continuation of application No. PCT/US05/42474, filed on Nov. 22, 2005.
(60) Provisional application No. 60/631,057, filed on Nov. 24, 2004.

(51) Int. Cl. A23L 2/66; A23C 3/08; A23C 9/14; A23L 2/68; A23C 9/142

(52) U.S. Cl. 426/330.2; 426/491; 426/519; 426/580; 426/585; 426/587; 426/590; 426/598

(57) ABSTRACT

A milk serum protein and calcium concentrate that is useful for fortifying acidic clear or opaque, carbonated or uncarbonated soft drinks without producing a cloudy appearance in clear drinks and with minimal effect upon the flavor of the beverage. Addition of liquid or melted fat or oil to drinks so fortified produces a beverage with a milk-like appearance.

### RELATED APPLICATIONS

This application is a continuation of PCT Application Serial No. PCT/US2005/042474, filed Nov. 22, 2005 and published on Jun. 1, 2006 as WO 2006/058083, which claims priority under 35 U.S.C. §119(e) to U.S. Provisional Patent Application Ser. No. 60/626,780, filed 10 Nov. 2004, which applications and publications are incorporated herein by reference and made a part hereof.

### FIELD OF THE INVENTION

The invention relates to a protein-calcium ingredient that can be added to fortify carbonated or uncarbonated beverages without precipitation at low pH and without producing a cloudy appearance in the beverage. The invention further relates to a beverage having a milk-like appearance that is made by adding melted or liquid fat or oil to the clear, low pH, protein-calcium fortified beverage.

### BACKGROUND OF THE INVENTION

Because carbonated beverages consist primarily of water, sugar, acid, flavoring, and carbon dioxide, many nutritionists consider them as “junk food” or dietary pollutants. The appeal of soft drinks to the young is strong, and as more nutritious beverages, such as milk and fruit juices, are replaced by soft drinks in the diets of children and teenagers, nourishing materials, such as calcium and protein, are replaced by “empty’ calories. Fortification of soft drinks with valuable nutrients without a detectable change in flavor or appearance would be a desirable step toward better nutrition.

Calcium is an essential nutrient; it is a major component of mineralized tissues and is required for normal growth and development of the skeleton and teeth. Over the last decade, calcium has enjoyed increased attention due to its potential role in the prevention of osteoporosis. Osteoporosis affects more than 25 million people in the United States and is the major underlying cause of bone fractures in postmenopausal women and the elderly.

The preferred approach to attaining optimal calcium intake is through dietary sources. Dairy products are the major contributors of dietary calcium because of their high calcium content (e.g., approximately 250-300 mg/8 oz of cow's milk) and frequency of consumption. However, many persons, especially women, prefer to limit their intake of dairy products for several reasons: (a) they dislike the taste of milk/milk products; and/or (b) they have lactose intolerance; and/or (c) they perceive that some dairy products are too high in fat or protein and may lead to weight gain. A number of calcium-fortified food products are currently available, including breads, cereals, juices, and fruit drinks.

The addition of calcium to water or clear beverages presents very significant problems. First, if highly soluble sources of calcium (calcium chloride, etc.) are used, a high level of soluble calcium leads to undesirable flavor and destabilization of proteins. Second, slightly soluble sources of calcium will not cause destabilization of protein micelles but they will precipitate out of the solution rapidly. Accordingly, the solubility of calcium sources must be balanced within a very small range of solubility to avoid such problems.

Therefore, it would be highly desirable to have a calcium source with which to fortify juices, beverages, and other liquid food products without coagulation and sedimentation, with improved palatability, and without bitterness or off-flavors.

Numerous unsuccessful and unsatisfactory efforts have been made in the past to provide beverages which combine the protein and other beneficial ingredients of milk with juices (or vice versa), particularly fruit juices. Relatively large amounts of juice are required to give a characteristic juice flavor to the milk, particularly with relatively mild flavored juices such as orange juice. However, when the acidic juice fraction is added to milk in sufficient amounts so as to lower the milk pH from the natural pH of 6.4-6.7 to below the isoelectric point of the milk's casein protein, then the protein precipitates and/or curdles. Additionally, various precipitates can form over time. Most previous art efforts have attempted to prepare juice-milk drinks using acidified or soured milk and especially acidified skim milk rather than sweet milk (i.e., milk at its natural pH). For example, the use of fermented milk causes flavor problems and coagulation problems.

Another approach has been to prepare drinks using only milk derived materials or milk fractions, i.e., materials not containing the proteins which would precipitate at lower pH values. A number of processes have attempted to avoid the problem by using whey protein concentrates, but other problems, such as disagreeable flavor, have arisen therewith.

The products which have been produced under prior art teachings are far from palatable, in many cases have lost essential vitamins during the processes employed, and are sufficiently devoid of “lasting” characteristics so as to deteriorate rapidly, in the absence of consumption substantially immediately following preparation, so as to become valueless with respect to palatability and nutritional value.

Therefore, it would be highly desirable to have a protein source with which to fortify juices, beverages, and other liquid food products so that the protein concentration approximates that of milk without coagulation and sedimentation, with improved palatability, and without bitterness or off-flavors. It would also be desirable to have a beverage that looks like milk, has the nutritional benefits of milk, but does not taste like milk.

### SUMMARY OF THE INVENTION

The present invention provides a novel protein-calcium ingredient that is a liquid or dry milk serum protein concentrate that can be added to existing or new, clear or opaque, carbonated or uncarbonated beverages. The milk serum protein concentrate has a very bland and agreeable flavor.

The milk serum protein concentrate of the present invention will not precipitate even at low pH values, does not produce a cloudy appearance in the beverage (unless fat or oil is added), is heat stable, has an agreeable flavor, and does not alter the appearance of the beverage. In some embodiments, the invention provides clear beverages with protein concentrations approximating that of milk. In other embodiments, the invention provides clear beverages with protein concentrations of about 3% to about 4% using the milk serum protein concentrate of the present invention. In still other embodiments, the invention provides clear beverages with protein concentrations below about 3% and above about 4%.

The present invention also provides a clear protein-calcium fortified beverage prepared using the novel milk serum protein concentrate of the present invention.

The present invention further provides a protein-calcium fortified beverage with a milk-like appearance that is prepared by adding melted or liquid fat or oil to the above clear protein-calcium fortified beverage.

### DETAILED DESCRIPTION OF THE INVENTION

The present invention provides a heat stable protein-calcium ingredient useful for fortifying clear or opaque soft drinks without precipitation and without changing the appearance of the beverage. Higher protein concentrations than have been heretofore been achieved in carbonated or uncarbonated acidic beverages are possible with the protein-calcium ingredient of the present invention.

Definitions

The following definitions are used unless otherwise described.

As used herein, the term “microfiltration” means a class of filtration that typically uses a porous membrane to separate materials larger than the pore size of the membrane and pressure on the upstream side of the membrane.

As used herein, the terms “ultrafiltered” and “ultrafiltration” mean filtration of molecular species so that some larger molecules are retained while smaller molecules are not. Typically a filtration device is used with a membrane that retains molecules with a molecular weight over a selected cut off and excludes small molecules. With respect to processing considerations, ultrafiltration can be performed to reduce the quantity of lactose, a relatively small molecule, and to concentrate the protein of a starting milk product, which is typically a reduced fat milk or a skim milk.

As used herein, the term “retentate” means liquids and solids retained by a microfiltration process. For example, a retentate can be a liquid milk product of milk microfiltration that is the concentrated milk feed and that contains all the components typically found in milk but with an increased solids mass percentage (as compared to the original milk) of casein, whey protein, fat, and minerals (ash), primarily being calcium, phosphorus, and magnesium.

As used herein, the term “permeate” means liquids and solids that pass through a microfiltration membrane. For example, a permeate can be a liquid milk product of milk microfiltration that contains only those milk components that are able to pass through the microfiltration membrane. Permeate from microfiltration of skim milk is typically composed of water, lactose, whey proteins, and minerals (ash), primarily being calcium, phosphorus, magnesium, sodium and potassium.

As used herein, the term “milk serum” means milk with the fat and casein micelles removed.

As used herein, the term “milk serum proteins” means the proteins present in milk serum, principally α-lactoglobulin, α-lactalbumin, bovine serum albumin, lactoferrin, and immunoglobulins, together or further separated into individual components or in different combinations.

As used herein the term “whey” means the watery portion of milk remaining after milk coagulation and removal of the curd in the process of making cheese. Whey can be obtained by acid, heat, and rennet coagulation of milk. There are two types of whey: sweet whey is manufactured during the making of rennet type hard cheeses, such as cheddar or Swiss cheese; acid whey (also known as sour whey) is obtained during the making of acid type cheeses, such as cottage cheese.

As used herein, the term “osteoporosis” refers to a reduction in the amount of bone mass. Two important factors influencing the occurrence of osteoporosis are optimal peak bone mass attained in the first two to three decades of life and the rate at which bone mass is lost in later years. Adequate calcium intake is critical to achieving optimal peak bone mass and modifies the rate of bone mass loss associated with aging.

As used herein, the term “low pH” means a pH below about 4.0.

As used herein, the term “about” is intended to encompass variations in amounts of ingredients or variations in measurements owing to variations in weighing and other measurement techniques, purity of ingredients, and the like, as would be known to the art worker. Such variations are usually no more than about ±0.5%.

Need for Calcium Intake

Calcium requirements vary throughout an individual's lifetime with greater needs occurring during the period of rapid growth in childhood and adolescence, pregnancy and lactation, and in later adult life. Table 1 presents the optimal calcium requirements or Recommended Daily Intake (RDI) which were established at a National Institute of Health (NIH) Conference on Optimal Calcium Intake, held Jun. 6-8, 1994. The participants at the NIH Conference considered former Recommended Dietary Allowances (RDA) (10th edition, 1989) for calcium intake as reference levels and used them as guidelines to determine optimal calcium intake in light of new data on calcium-related disorders.

TABLE 1
Optimal Calcium Intakes

| | |
|---|---|
| | OPTIMAL DAILY |
| | INTAKE |
| GROUP | (in mg of calcium) |

Infants

| | |
|---|---|
| Birth-6 months | 400 |
| 6 months-1 year | 600 |

Children

| | |
|---|---|
| 1-5 years | 800 |
| 6-10 years | 800-1,200 |

Adolescents/Young Adults

| | |
|---|---|
| 11-24 years | 1,200-1,500 |

Men

| | |
|---|---|
| 25-65 years | 1,000 |
| Over 65 years | 1,500 |

Women

| | |
|---|---|
| 25-50 years | 1,000 |

Over 50 years (postmenopausal)

| | |
|---|---|
| On estrogens | 1,000 |
| Not on estrogens | 1,500 |
| Over 65 | 1,500 |
| Pregnant and nursing | 1,200-1,500 |

National consumption data indicate most females over the age of eleven, as well as elderly men, consume amounts of calcium below recommended levels. According to the Second National Health and Nutrition Examination Survey, the median daily calcium intake for women in the United States was 574 mg.

To maximize calcium absorption, food selection decisions should include consideration of information on the bioavailability of the calcium contained in the food. Bioavailability (absorption) of calcium from food depends on the food's total calcium content and the presence of components which enhance or inhibit calcium absorption. Bioavailability of minerals in food has been traditionally tested by the balance method, which estimates absorption from the difference between ingested intake and fecal output. This approach works well for many nutrients where the difference between intake and excretion is large, but is less well suited for an element such as calcium. A decline in absorption from 30% to 20% could have profound nutritional significance but would be difficult to detect using the balance method. In contrast, isotopic methods estimate absorption directly from the appearance of the ingested tracer in body fluids. Future clinical evaluations of the bioavailability of calcium from the liquid nutritional product of the present invention will use a state-of-the-art isotope tracer method.

The United States Food and Drug Administration (FDA) has advised that, in order for calcium-containing food ingredients in conventional foods or calcium supplement products to be considered eligible to bear the authorized calcium/osteoporosis health claim, they must meet the requirements of 21 C.F.R. §101.14, which include that they have been shown to the FDA's satisfaction to be safe and lawful under the applicable safety provisions of the Federal Food, Drug, and Cosmetic Act (56 FR at 60699). Of the 36 or more calcium-containing ingredients identified by the agency as currently in use, the FDA advised that only the following 10 compounds had been demonstrated to be safe and lawful for use in a dietary supplement or as a nutrient supplement: calcium carbonate, calcium citrate, calcium glycerophosphate, calcium oxide, calcium pantothenate, calcium phosphate, calcium pyrophosphate, calcium chloride, calcium lactate, and calcium sulfate (56 FR at 60691).

Method of Making

The present invention provides a novel method for making a low pH milk serum protein concentrate that can be mixed with low pH clear or cloudy beverages in order to fortify the beverages with protein and calcium. In the first step of the novel method, the milk serum protein concentrate is prepared by microfiltering milk to produce a permeate containing water, milk serum proteins, calcium, and other water-soluble components of milk.

The milk used in the process of the present invention may be whole milk, reduced fat milk, or skim (non-fat) milk. Skim milk is preferred. The skim milk may be liquid or dried. Dried skim milk is reconstituted with water before using in the process of the present invention.

The non-fat dried milk used in the present invention can be either low heat, medium heat, or high heat non-fat dried milk. These designations are an indication of the extent of heat exposure received by the milk during drying. In drying the milk, a portion of the non-casein milk protein is denatured. This denaturation of the non-casein proteins of milk by heat is used to determine the amount of heat exposure received by the milk. After precipitation of the casein, a determination is made of the amount of protein left in the whey. This procedure, developed by Harland and Ashworth, is designated as the whey protein nitrogen test. With this test, low heat non-fat dried milk is defined for use herein as having not less than 6.0 milligrams whey protein nitrogen per gram of milk powder. The other two known forms of non-fat dried milk, i.e., high heat and medium heat, are categorized as follows: high heat, not over 1.5 milligrams/gram, and medium heat, over 1.5 but less than 6.0 milligrams/gram. The preferred non-fat dried milk is low heat non-fat dried milk.

Low heat non-fat dried milk is usually prepared by spray drying. High heat non-fat dried milk is usually prepared by drying the milk on a rotating steam heated drum or roller. For the preferred low heat non-fat dried milk, any drying process can be used as long as the product has 6.0 milligrams or more whey protein nitrogen per gram of milk powder.

Skim milk microfiltration is a protein selective process that normally retains all of the casein in the retentate and passes a major portion of the whey protein into the permeate. The microfiltration is generally carried out utilizing a uniform transmembrane pressure loop with retentate circulating in the loop containing a microfiltration membrane and the permeate passing through a microfiltration membrane leaving as one product stream and the retentate being obtained as the other product once all the permeate is recovered.

The microfiltration membrane pore size can range, for example, from 0.05 to 0.2 microns, or ranges from 0.1 microns to 0.2 microns, or is about is 0.1 microns. Alumina-based ceramic membranes of 0.1 micron nominal pore diameter, useful for the microfiltration herein, are available from U.S. Filter Corp. (Warrendale, Pa.) under the trademark Membralox® P19-40. The uniform transmembrane pressure can range, for example, from 30 to 400 kPa.

After this microfiltration step, the permeate typically contains about 0.1 to about 1% protein by weight, including about 0.5% protein by weight. While microfiltration is the preferred method of separating serum proteins from casein and fat in milk, other physical methods, such as ion exchange or gel filtration, may used.

In the second step of the novel method, the permeate produced in the microfiltration step is ultrafiltered to concentrate the proteins and to yield a liquid serum protein concentrate. The molecular weight cut off for the ultrafiltration typically is on the order of about 10,000 Daltons. The proteins in the microfiltration permeate are predominately beta-lactalbumin and alpha-lactoglobulin. The concentration of proteins in the serum protein concentrate is typically about 10% by weight or higher. Alternatively, a microfiltration permeate containing about 0.5% protein may be used directly in the third step hereinbelow.

The serum protein concentrate prepared from skim milk in this manner has a protein composition different from that of whey protein concentrates produced from whey, e.g., it does not contain glycomacropeptide from kappa casein, has a lower fat content, etc. In addition the flavor of the serum protein concentrate is much blander and more agreeable than that of whey protein concentrates produced from whey.

The viscosity of the liquid serum protein concentrate is directly proportional to the protein concentration thereof. The viscosity may be varied by varying the selected molecular weight cut off in the ultrafiltration step.

In the third step, the serum protein concentrate is acidified very rapidly with a food grade acid, with vigorous mixing, to a pH below about 4.0. This step avoids the precipitation of the proteins, which would occur if the pH were at least about 4.0 to about 5.0 after the acidification. In some embodiments, a suitable pH is about 3.3 or lower, for example, a pH of about 2.5 to about 3.3 can be used. The acidified serum protein concentrate exists as a clear solution with no precipitation. The acidification step may be conducted as a batchwise process or as a continuous process, such as by injection of acid into a flowing stream of liquid serum protein concentrate. If this acidification is conducted with the microfiltration permeate, a low pH concentrate results without the clean flavor and appearance of that produced with the ultrafiltration permeate. The former permeate is nonetheless useful and practicable for some beverage applications.

Suitable food grade acids for use in the process of the present invention, alone or in combination, include acetic acid, lactic acid, propionic acid, carbonic acid, citric acid, hydrochloric acid, phosphoric acid, sulfuric acid, sulfurous acid, and the like. The choice of acid will vary depending upon the nature of the beverage to be fortified. Phosphoric acid is especially preferred for use in fortifying carbonated soft drinks. Phosphoric acid has the ability to overcome the buffering capacity of the protein quickly and the ability to lower the pH without producing as strong an acid flavor, relative to that produced with other acids. At this stage, other ingredients, including flavorings and other fortification ingredients, such as vitamins, may be incorporated to produce a beverage concentrate for later reconstitution.

In the fourth step, the acidified, clear, liquid serum protein concentrate is heat processed. Suitable temperatures and heating times are those that do not cause precipitation or cloudiness, typically about 185° F. to about 200° F., including about 190° to about 200° F. The concentrate is held at the elevated temperature for a brief period. Typical holding times are from 15 seconds to 15 minutes, including 15 to 30 seconds.

The resulting liquid protein concentrate has a refrigerated shelf-life of more than one year, and is shelf-stable at room temperature if packaged aseptically. The liquid protein concentrate can be used as such to fortify beverages. Alternatively, the liquid protein concentrate can be dried and reconstituted later. Using the liquid protein concentrate eliminates both the cost and problems associated with making a dry concentrate.

The liquid serum protein concentrate of the invention may be used to produce stable, clear, carbonated or uncarbonated beverages with protein concentrations in the range of 3 to 4% protein at pH values in the range of about 2.7 to about 6.7. Lower or higher levels of fortification and lower or higher pH levels can be used. Thus, the fortified beverages of the invention may have a protein concentration lower than, higher than, or identical to that of milk. At 3% added protein, a fortified beverage of the invention contains about one-third the level of calcium present in milk, but the calcium level can be increased or decreased depending on the needs of the particular application by modification of the preparation process. The liquid serum protein concentrate of the invention may be prepared with lactose or virtually without (about 0.1%) lactose using appropriate conditions known to the art at the ultrafiltration step.

In another embodiment, the stable, clear, protein-calcium fortified, carbonated or uncarbonated beverages produced above may be given a milk-like appearance by adding melted or liquid fat or oil thereto. Suitable fats include milk fat or plant fats and oils. Plant fats include oils of vegetables and seeds. Examples include corn, sesame, canola, soybean, castor, peanut, olive, arachis, maize, almond, flax, safflower, sunflower, rape, coconut, palm, babassu, and cottonseed oils.

Fat contents in the beverage so produced are typically from about 0.1% to about 40%. The melted or liquid fat is typically added to the stable, clear, protein-calcium fortified, carbonated or uncarbonated beverages of the present invention, followed by mixing in a high shear blender and then followed by homogenization. The addition of the fat does not cause precipitation of proteins.

If no color is added, the resulting beverage has the exact appearance of milk. Of course, acceptable food coloring may be added to impart a variety of different colors and appearances to the beverage.

It is surprising and unexpected that addition of melted or liquid fat in the above manner would produce a beverage with a milk-like appearance without precipitation of proteins. For example, if milk fat is added to whey and then homogenized, the resulting liquid is cloudy white and does not resemble milk. If the pH of this cloudy white liquid is lowered, followed by heating, the proteins precipitate.

The liquid serum protein concentrate of the invention may also be used to fortify cloudy or opaque, carbonated or uncarbonated beverages. The protein-calcium ingredient of the invention does not affect the extent of the cloudiness or opacity of the unfortified cloudy or opaque beverage.

There may be a slight change in the mouth feel of the fortified beverage vis-à-vis its unfortified counterpart. The viscosity of the beverage increases at higher levels of protein fortification. The flavor of the liquid serum protein concentrate is agreeable and bland. Typically, the flavor of the liquid serum protein concentrate cannot be detected at 1 to 2% added protein. If the beverage itself has a strong flavor of its own, higher protein fortification levels, such as 3% or higher, are possible without detection of the flavor of the added protein-calcium ingredient.

The soft drinks which can be fortified with protein in accordance with the present invention include any acidic soft drink, either natural or formulated, regular or diet, which has a final pH between the range of from about 2.7 to about 6.7. These include cola, root beer, Gatorade® or Gatorade®-type sports drinks, citrus and citrus flavored drinks including natural orange juice, lemonade, lime, lemon-lime, and the like. The soft drink can be carbonated or non-carbonated as desired, although a carbonated beverage is preferred. A typical citrus-flavored beverage composition includes 11% sugar, 88% water, and 0.23% citric acid. Clarity and heat stability are optimal at the extremes of the above pH range. The fortified soft drinks are heat stable, i.e., the protein does not precipitate, when heated at 195° F. for five minutes.

The extent of protein fortification can be increased or decreased. A sufficient amount of protein-calcium ingredient should be used to provide at least 0.1% by weight protein in the final drink. The preferred maximum protein fortification level is up to about 5%, but higher levels of fortification are possible. It is preferred that the protein fortification range in amounts of from 0.1 to about 1% protein, based on Kjeldahl nitrogen times 6.38. The actual amount of protein-calcium ingredient needed to attain these levels is dependent on the percentage protein therein. For instance, a protein concentrate having 50% protein would be used within the amounts of from about 0.2% to about 2.0% to achieve a fortification range of 0.1% to 1%. The exact amounts can be easily calculated by one skilled in the art. The protein-calcium ingredient can have as little as about 0.5% protein if it is acidified directly as collected from the microfiltration process.

It has been found that the compositions of the invention at the pHs stated are resistant to thermal denaturation and precipitation. The soft drinks fortified in accordance with the present invention can be pasteurized without a precipitation of the protein. The protein-calcium ingredient of the invention may be added to a suitable beverage; the fortified beverage may then be processed thermally and transferred into bottles or cans. A thermally processed fortified beverage according to the invention is shelf-stable for at least one year.

If thermal processing is not employed, the fortified beverages of the invention should be refrigerated. Examples of soft drinks that are not processed thermally include those beverages typically refrigerated, including orange juice not made from concentrate. Once fortified, they should be refrigerated in a manner suitable to that employed for the unfortified counterpart. The refrigerated shelf life of the fortified beverage is virtually identical to that of the refrigerated unfortified beverage.

The fortified beverages of the invention are prepared by blending the liquid serum protein concentrate of the invention with a low pH unfortified clear or cloudy beverage. The amount of the liquid serum protein concentrate used is the amount calculated to produce a desired level of fortification in the beverage. Suitably, the pH of the liquid serum protein concentrate is adjusted to the pH of the unfortified beverage before the concentrate and beverage are blended.

The above blending procedure lends itself to application in food service machines or vending machines. In such situations, the low pH liquid serum protein concentrate may be mixed on demand with flavor concentrate and carbonated or uncarbonated water.

The invention will now be illustrated by the following non-limiting examples.

### EXAMPLE 1

### Preparation of Low pH Liquid Serum Protein Concentrate

Skim milk was microfiltered through a 0.1 micron pore size microfiltration membrane to produce a permeate containing water, milk serum proteins, calcium, and other water-soluble components of milk. The permeate contained about 0.5% protein by weight, mostly alpha-lactalbumin and beta-lactoglobulin. The microfiltration permeate was ultrafiltered using a molecular weight cut off for the ultrafiltration of 10,000 Daltons to yield a liquid serum protein concentrate containing about 10% protein by weight. The liquid serum protein concentrate was acidified very rapidly, with vigorous mixing with a mechanical mixer, to a pH of 3.3 or lower with food grade phosphoric acid. The low pH liquid serum protein concentrate was heat processed at 185° to 190° F. for 15 to 30 seconds without any resulting precipitation or cloudiness.

### EXAMPLE 2

### Process of Fortifying Acidic Soft Drinks with Low pH Liquid Serum Protein Concentrate

Gatorade® was blended with the low pH liquid serum protein concentrate of the invention by first lowering the pH of the concentrate to pH 2.90 to 3.15, the pH of Gatorade®, with food grade phosphoric acid. The mixture was heated to 185° to 1 90° F., cooled, and filled into beverage containers. The amount of low pH liquid serum protein concentrate was calculated to produce 3% by weight protein and 55 mg calcium for 8 ounces of fortified Gatorade®. Of course, higher calcium levels and protein concentrations are provided with larger serving sizes. A fortified cola was prepared in a similar manner.

### REFERENCES

1. Journal of the American Medical Association 1994, 2 72(24), 1942-1948.
2. Journal of the American Dietetic Association 1993, 93(9), 1000-1006.
3. Journal of the American Medical Association 1994, 272(24), 1942-1948 at 1943.
4. USDA NFCS, CFS II Report No. 86-93 (1988).
5. DIETARY INTAKE SOURCE DATA: UNITED STATES, 1976-80, Data From the National Health Survey, Series II, No. 231, DHHS Publication No. (PHS), pages 83-1681 (1983).
6. J. Dairy Science 1945, 28, 879.

All patents and publications referenced or mentioned herein are indicative of the levels of skill of those skilled in the art to which the invention pertains, and each such referenced patent or publication is hereby incorporated by reference to the same extent as if it had been incorporated by reference in its entirety individually or set forth herein in its entirety. Applicants reserve the right to incorporate physically into this specification any and all materials and information from any such cited patents or publications.

The specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that varying substitutions and modifications may be made to the invention disclosed herein without departing from the scope and spirit of the invention.

The invention described illustratively herein suitably may be practiced in the absence of any element or elements, or limitation or limitations, which is not specifically disclosed herein as essential. The methods and processes described illustratively herein suitably may be practiced in differing orders of steps, and that they are not necessarily restricted to the orders of steps indicated herein or in the claims. As used herein and in the appended claims, the singular forms “a,” “an,” and “the” include plural reference unless the context clearly dictates otherwise. Thus, for example, a reference to “an acidic beverage” includes a plurality of such beverages, and so forth. Under no circumstances may the patent be interpreted to be limited to the specific examples or embodiments or methods specifically disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicants.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

Other embodiments are within the following claims. In addition, where features or aspects of the invention are described in terms of Markush groups, those skilled in the art will recognize that the invention is also thereby described in terms of any individual member or subgroup of members of the Markush group.

1. A milk serum protein and calcium concentrate that comprises about 0.5% to greater than about 10% milk serum proteins.

2. The concentrate of claim 1, wherein the concentrate is acidified.

3. The concentrate of claim 2, wherein the acidified concentrate is a clear solution with substantially no precipitate.

4. The concentrate of claim 2, wherein the concentrate is acidified to a pH of 4.0 or less.

5. The concentrate of claim 1, wherein the concentrate further comprises about 0.1% to about 40% fat.

6. The concentrate of claim 5, wherein the fat is a milk fat or a plant fat.

7. The concentrate of claim 6, wherein the plant fat is a vegetable fat or a seed fat.

8. The concentrate of claim 1, wherein the concentrate is heat processed.

9. The concentrate of claim 1, which is in liquid form.

10. The concentrate of claim 1, wherein the concentrate is useful for fortifying soft drinks.

11. A protein or calcium fortified acidic beverage with a milk-like appearance that was made from the concentrate of claim 1, wherein the beverage has a protein concentration lower than, about equal to, or greater than the protein concentration of milk.

12. A protein or calcium fortified acidic beverage that comprises a protein concentration lower than, about equal to, or greater than the protein concentration of milk.

13. The fortified beverage of claim 12 that is clear.

14. The fortified beverage of claim 12 that is opaque.

15. The fortified beverage of claim 12 that has a milk-like appearance.

16. The fortified beverage of claim 12 that has a protein concentration about equal to or greater than the protein concentration of milk.

17. The fortified beverage of claim 12 that is a carbonated beverage.

18. The fortified beverage of claim that is an uncarbonated beverage.

19. The fortified beverage of claim 12 that is a cola.

20. The fortified beverage of claim 12 that is a sports drink.

21. A process for making a milk serum protein and calcium concentrate that comprises about 0.5% to greater than about 10% milk serum proteins, which process comprises:
(a) microfiltering milk to produce a permeate that comprises water-soluble milk proteins; and
(b) ultrafiltering said permeate to concentrate the milk serum proteins to about 0.5% to greater than about 10% by weight and thereby producing a milk serum protein and calcium concentrate that comprises about 0.5% to greater than about 10% milk serum proteins.

22. The process of claim 21, wherein the process further comprises: (c) acidifying the concentrate very rapidly with vigorous mixing to a pH below about 4.0.

23. The process of claim 21, wherein the permeate comprises milk serum proteins, water, calcium, or a mixture thereof.

24. The process of claim 21, wherein the milk that is microfiltered is skim milk.

25. The process of claim 21, wherein the protein concentration of the permeate is about 0. 1% to about 1% by weight.

26. A process for making a clear acidified milk serum protein and calcium concentrate that comprises about 0.5% to greater than about 10% milk serum proteins, which process comprises:
(a) microfiltering milk to produce a permeate which comprises about 0.5% to greater than about 10% milk serum proteins; and
(b) acidifying the concentrate very rapidly with vigorous mixing to a pH below about 4.0.

27. The process of claim 26, which further comprises heat processing the acidified concentrate.

28. The process of claim 27, wherein the heat processing is conducted at 185° to 190° F. without resulting in any precipitation or cloud formation.

29. The process of claim 26, wherein a food grade acid is used for acidifying the concentrate.

30. A process for making a protein and calcium fortified acidic beverage, which process comprises blending the milk serum protein and calcium concentrate of claim 1 with an acidic clear or cloudy unfortified beverage.

31. The process of claim 30, wherein the process further comprises adding melted or liquid fat to the beverage.

32. The process of claim 30, which further comprises mixing in a high shear blender and homogenization.

33. The process of claim 30, wherein the pH of the milk serum protein and calcium concentrate is adjusted to the pH of the acidic unfortified beverage before the two are blended.

34. The process of claim 30, wherein the milk serum protein and calcium concentrate is used in an amount calculated to produce a desired level of fortification in the beverage.

35. A protein and calcium fortified acidic beverage with a milk-like appearance made by the process of claim 30.

36. The beverage of claim 35, having fat content of about 0.1% to about 40%.

37. The beverage of claim 35, wherein the fat is a milk fat or a plant fat.

38. The beverage of claim 37, wherein the plant fat is a vegetable fat or a seed fat.

39. The beverage of claim 37, further comprising food coloring.
